(19) United States
(12) Patent Application Publication
(10) Pub. No.: US 2017/0279157 A1
(43) Pub. Date: Sep. 28, 2017

(54) RECHARGEABLE BATTERY

(71) Applicant: SAMSUNG SDI CO., LTD., Yongin-si (KR)

(72) Inventors: Hyun-Soo LEE, Yongin-si (KR); Min-Hyung GUEN, Yongin-si (KR)

(21) Appl. No.: 15/365,182

(22) Filed: Nov. 30, 2016

(30) Foreign Application Priority Data
Mar. 22, 2016 (KR) 10-2016-0034247

(51) Int. Cl. H01M 10/0587; H01M 2/02; H01M 10/0525; H01M 4/13; H01M 2/20

(52) U.S. Cl. CPC H01M 10/0587; H01M 4/13; H01M 2/204; H01M 2/206; H01M 10/0525; H01M 2/0217; H01M 2/024; H01M 2220/30; H01M 2220/20

(57) ABSTRACT

A rechargeable battery includes: a first electrode assembly and a second electrode assembly, each including a first electrode and a second electrode configured with an electrode plate and an electrode uncoated region; a case for receiving the first electrode assembly and the second electrode assembly and including an opening; a cap assembly combined with the case to seal the opening; and a current collecting member electrically connected between the electrode uncoated region of the first electrode assembly and the electrode uncoated region of the second electrode assembly, and the current collecting member has a plurality of holes arranged between a first overlapping region of the current collecting member that overlaps a first side of the electrode uncoated region of the first electrode assembly and a second overlapping region of the current collecting member that overlaps a first side of the electrode uncoated region of the second electrode assembly.

### CROSS-REFERENCE TO RELATED APPLICATION

This application claims priority to and the benefit of Korean Patent Application No. 10-2016-0034247, filed on Mar. 22, 2016 in the Korean Intellectual Property Office, the entire content of which is incorporated herein by reference.

### BACKGROUND

1. Field

Aspects of embodiment the described technology relate to a rechargeable battery.

2. Description oaf the Related Art

A rechargeable battery is a battery that can be charged and discharged, unlike a primary battery that cannot be recharged. A low-capacity rechargeable battery has been used for small portable electronic devices, such as a mobile phone, a laptop computer, or a camcorder, and a large-capacity battery has been widely used as a power supply for driving a motor, such as for a hybrid vehicle or an electric vehicle.

Recently, a high-power rechargeable battery using a non-aqueous electrolyte of a high energy density has been developed. The high-power rechargeable battery is configured as a large-capacity rechargeable battery by connecting a plurality of rechargeable batteries in series to be able to be used for devices requiring a large amount of power, for example, for driving a motor, such as for an electric vehicle.

Electrode tabs of the rechargeable batteries may be connected with electrode leads of adjacent battery cells, access members, or bus bars, and they may be connected by use of ultrasonic welding.

However, welded portions may be damaged by ultrasonic vibrations generated by the ultrasonic welding and may cause a disconnection or a short circuit.

The above information disclosed in this Background section is only for enhancement of understanding of the background of the described technology and therefore it may contain information that does not form the prior art that is already known in this country to a person of ordinary skill in the art.

### SUMMARY

According to an aspect of the described technology, a rechargeable battery is provided in which damage caused by ultrasonic vibrations is minimized or reduced.

According to one or more exemplary embodiments, a rechargeable battery includes: a first electrode assembly and a second electrode assembly, each including a first electrode and a second electrode configured with an electrode plate and an electrode uncoated region; a case for receiving the first electrode assembly and the second electrode assembly and including an opening; a cap assembly combined with the case to seal the opening; and a current collecting member electrically connected between the electrode uncoated region of the first electrode assembly and the electrode uncoated region of the second electrode assembly, and the current collecting member has a plurality of holes arranged between a first overlapping region of the current collecting member that overlaps a first side of the electrode uncoated region of the first electrode assembly and a second overlapping region of the current collecting member that overlaps a first side of the electrode uncoated region of the second electrode assembly.

The holes may be arranged as a matrix.

The current collecting member may connect the first electrode of the first electrode assembly and the first electrode of the second electrode assembly, and the rechargeable battery may further include another current collecting member connecting the second electrode of the first electrode assembly and the second electrode of the second electrode assembly.

The current collecting member may include a first current collecting plate and a second current collecting plate connected with a first end of the first current collecting plate, and may include a wrinkle portion between the first current collecting plate and the second current collecting plate.

The wrinkle portion may have at least one through hole.

The at least one through hole may have a quadrangle shape with a long side extending in a direction traversing the wrinkle portion.

The at least one through hole may include a plurality of through holes arranged at intervals in a length direction of the wrinkle portion.

The first current collecting plate and the second current collecting plate may be connected with each other in a stepwise manner.

A first end of the first current collecting plate connected with the second current collecting plate may be narrower than the second current collecting plate.

The first current collecting plate may include a slit formed along the first end of the first current collecting plate connected with the second current collecting plate.

The first electrode assembly and the second electrode assembly may be respectively spirally wound with respect to a winding axis, and may be inserted into the case in a direction parallel to the winding axis.

The electrode uncoated region of the first electrode and the electrode uncoated region of the second electrode may include a first uncoated region protruding toward the cap assembly from the electrode plate and a second uncoated region having a first side bent from the first uncoated region and contacting the current collecting member.

The second uncoated region of the first electrode assembly and the second uncoated region of the second electrode assembly may be bent in opposite directions to face each other.

When the current collecting member is formed according to one or more embodiments of the present invention, a damage caused by ultrasonic vibrations may be minimized or reduced when it is combined through an ultrasonic welding, thereby reducing generation of defects.

### BRIEF DESCRIPTION OF THE DRAWINGS

FIG. 1 shows a perspective view of a rechargeable battery according to an exemplary embodiment.

FIG. 2 shows a cross-sectional view of the rechargeable battery of FIG. 1, taken along the line II-II of FIG. 1.

FIG. 3 shows a cross-sectional view of the rechargeable battery of FIG. 1, taken along the line III-III of FIG. 1.

FIG. 4 shows a perspective view of a partial configuration of the rechargeable battery of FIG. 1.

FIG. 5 shows a perspective view of a current collecting member included in FIG. 4.

FIG. 6 to FIG. 11 shoe perspective views of a current collecting member according to further exemplary embodiments.

### DETAILED DESCRIPTION

In the following detailed description, only certain exemplary embodiments have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

The size and thickness of each component illustrated in the drawings may be arbitrarily illustrated in the drawings for better understanding and ease of description, but the present invention is not limited to the illustrations.

In the drawings, the thickness of layers, films, panels, regions, etc. may be exaggerated for clarity. The thickness of the layers, films, panels, regions, etc. may be enlarged in the drawings for better understanding and ease of description It will be understood that when an element such as a layer, film, region, or substrate is referred to as being “on” another element, it can be directly on the other element or one or more intervening elements may also be present.

In addition, unless explicitly described to the contrary, the word “comprise” and variations such as “comprises” or “comprising” will be understood to imply the inclusion of stated elements but not the exclusion of any other elements. Throughout this specification, is to be understood that the term “on” and similar terms are used generally and are not necessarily related to a gravitational reference.

A rechargeable battery according to an exemplary embodiment will be described below in further detail with reference to accompanying drawings.

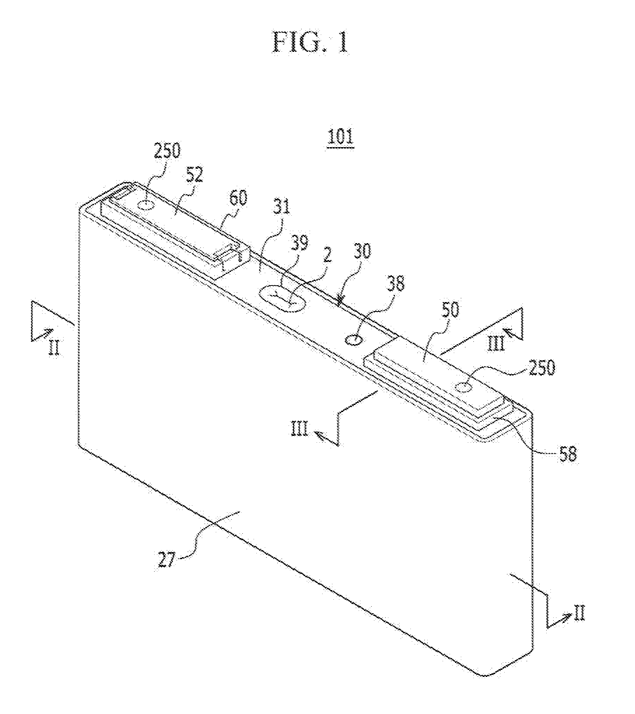

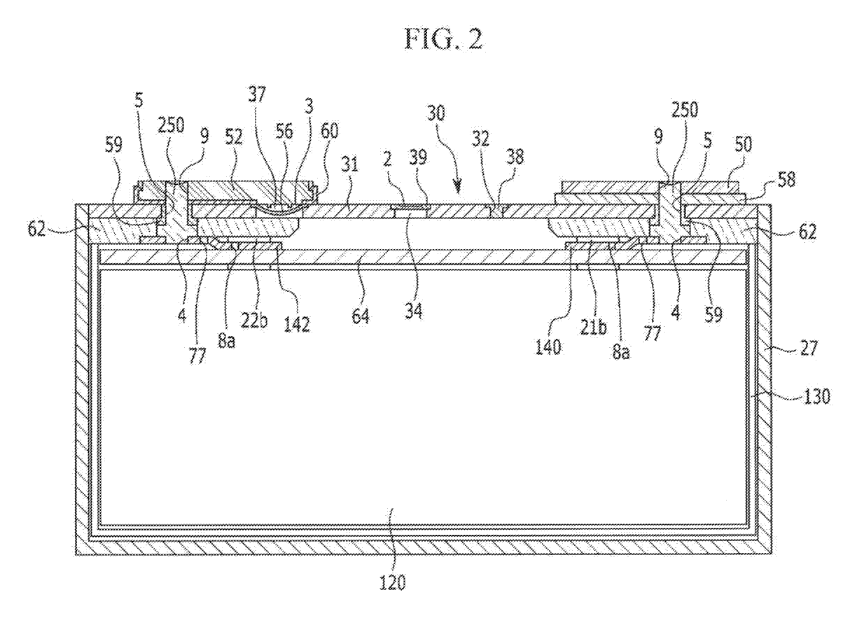

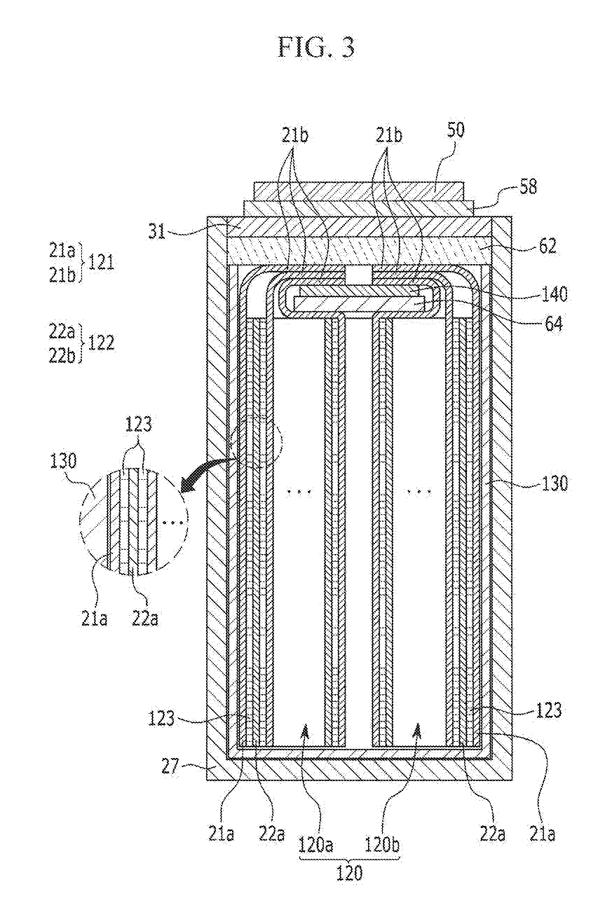

FIG. 1 shows a perspective view of a rechargeable battery according to an exemplary embodiment; FIG. 2 shows a cross-sectional view of the rechargeable battery of FIG. 1, taken along the line II-II of FIG. 1; and FIG. 3 shows a cross-sectional view of the rechargeable battery of FIG. 1, taken along the line III-III of FIG. 1.

As shown in FIG. 1 to FIG. 3, a rechargeable battery 101 according to an embodiment includes an electrode assembly 120 spirally wound with a separator 123 provided between a first electrode 121 and a second electrode 122, a current collecting member 140 electrically connected to the electrode assembly 120, case 27 in which the current collecting member 140 and the electrode assembly 120 are provided, and a cap assembly 30 combined to an opening of the case 27.

The rechargeable battery 101 will be exemplarily illustrated as a prism-shaped lithium ion rechargeable battery. However, the present invention is not limited thereto, and it may be applied to various types of batteries such as a lithium polymer battery, a cylindrical battery, etc.

In an embodiment, the electrode assembly 120 may include a plurality of assemblies 120a and 120b, and the assemblies 120a and 120b may be spirally wound with respect to a winding axis while the separator 123 is provided between the first electrode 121 and the second electrode 122 and they may be pressurized to become flat. The first electrode 121 and the second electrode 122 include electrode active portions 21a and 22a that are regions generated by applying an active material to a thin plate formed of a metal foil, and electrode uncoated region 21b and 22b to which the active material is not applied.

The first electrode active portion 21a may be formed by applying an active material, such as a transition metal oxide, to a metal foil, such as aluminum, and the second electrode active portion 22a may be formed by applying an active material, such as graphite or carbon, to a metal foil, such as copper or nickel.

In an embodiment, the first electrode uncoated region 21b and the second electrode uncoated region 22b are protruded in parallel toward the cap assembly 30 from one side of the first electrode active portion 21a and the second electrode active portion 22a, respectively. In an embodiment, the first electrode uncoated region 21b and the second electrode uncoated region 22b may be cut to protrude from the metal foil such as to be integrally formed with the metal foil of the first electrode active portion 21a and the second electrode active portion 22a, respectively.

The first electrode uncoated region 21b and the second electrode uncoated region 22b have opposite polarities and are separately disposed from each other with a gap therebetween.

Further, the first electrode 121 and the second electrode 122 are spirally wound or overlap each other such that the first electrode uncoated region 21b and the second electrode uncoated region 22b may be formed by overlapping a plurality of thin films. When thin films of a plurality of thin films are formed to overlap each other, they may be connected to each other to contact one another by ultrasonic welding to facilitate a transport of current.

The separator 123 may be provided between the first electrode active portion 21 a and the second electrode active portion 22a, may serve to prevent or substantially prevent a short circuit, may allow lithium ions to move, and may be formed of polyethylene, polypropylene, or a composite film of polyethylene and polypropylene, for example.

In an embodiment, the electrode assembly 120 may be inserted into the case 27 in a parallel direction with the winding axis, and the electrode assembly 120 may be substantially received into the case 27 with an electrolyte solution. The electrolyte 20solution may be composed of an organic solvent, such as EC, PC, DEC, EMC, or DMC, and a lithium salt such as LiPF₆ or LiBF₄. The electrolyte solution may be in a liquid, solid, or gel state.

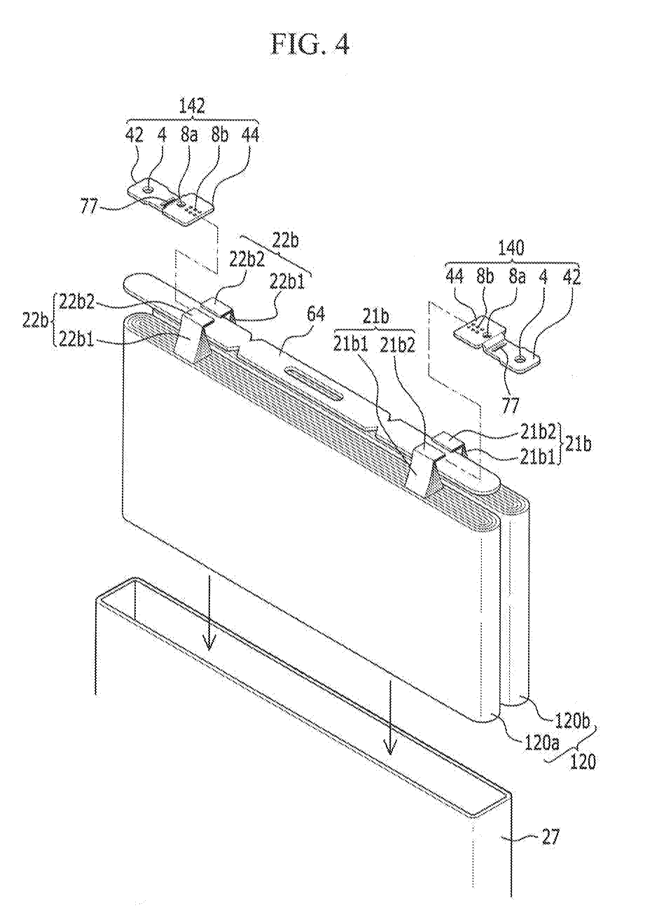

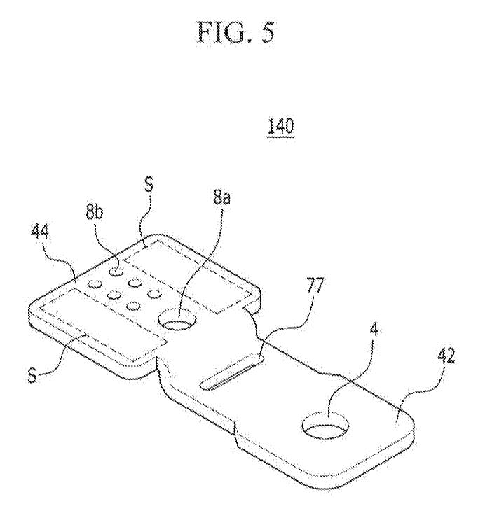

The electrode assembly 120, in an embodiment, may include a first electrode assembly 120a and a second electrode assembly 120b, which will be further described with reference to FIG. 4 and FIG. 5.

FIG. 4 shows a perspective view of a partial configuration of the rechargeable battery of FIG. 1; and FIG. 5 shows a perspective view of a current collecting member included in FIG. 4. In FIG. 4, the cap assembly 30 and a first insulating member are not shown for convenience of illustration.

As shown in FIG. 4, the first electrode assembly 120a and the second electrode assembly 120b included in the electrode assembly 120 may be electrically connected.

Regarding the first electrode assembly 120a and the second electrode assembly 120b, the electrode uncoated regions having a same polarity are electrically connected to each other by the current collecting member. That is, first electrode uncoated regions 21b of the first electrode assembly 120a and the second electrode assembly 120b are electrically connected to each other by the first current collecting member 140, and second electrode uncoated regions 22b of the first electrode assembly 120a and the second electrode assembly 120b are electrically connected to each other by a second current collecting member 142.

In an embodiment, the first electrode uncoated regions 21b of the first electrode assembly 120a and the second electrode assembly 120b are bent to face each other, and the second electrode uncoated regions 22b of the first electrode assembly 120a and the second electrode assembly 120b are bent to face each other. Therefore, each of the first electrode uncoated regions 21b may include a first uncoated region 21b1 connected with the metal foil of the first electrode active portion 21a and protruded in a direction of the cap assembly 30, and a second uncoated region 21b2 having a first side extending from the first uncoated region 21b1 and contacting the current collecting member 140, and, similarly, each of the second electrode uncoated regions 22b may include a first uncoated region 22b1 connected with the metal foil of the second electrode active portion 22a and protruded in a direction of the cap assembly 30, and a second uncoated region 22b2 having a first side extending from the first uncoated region 22b1 and contacting the current collecting member 142.

A first side (i.e. a side which is relatively close to a cap plate of the cap assembly 30) of the first current collecting member 140 may contact a first side (i.e. a side which is relatively close to the first current collecting member 140) of the second uncoated region 21b2 to be electrically connected to each other, and a first side (i.e. a side which is relatively close to the cap plate) of the second current collecting member 142 may contact a first side (i.e. a side which is relatively close to the second current collecting member 142) of the second uncoated region 22b2 to be electrically connected to each other.

In an embodiment, the first current collecting member 140 and the second current collecting member 142 may have a same shape, and, therefore, the first current collecting member 140 will be mainly described with reference to drawings.

As shown in FIG. 5, in an embodiment, the first current collecting member 140 includes a first current collecting plate 42 having a substantially quadrangular plate shape, and a second current collecting plate 44 having a first end connected with the first current collecting plate 42 and having a substantially quadrangular plate shape. The first current collecting plate 42 and the second current collecting plate 44 may be integrally formed and may be formed of a low resistance metal, such as copper.

In an embodiment, the first current collecting plate 42 and the second current collecting plate 44 may be connected in a stepwise manner. This compensates for a step caused by a thickness of the second uncoated region of the electrode uncoated region when the second current collecting plate 44 is connected to the second uncoated region, and the step between the second current collecting plate 44 and the first current collecting plate 42 may be formed to be similar to the thickness of the electrode uncoated region and thereby minimize or reduce a generation of a step when the current collecting member is connected to the electrode uncoated region.

In an embodiment, the first current collecting plate 42 has a first terminal hole 4, where the first terminal hole 4 represents a hole by which the first current collecting plate 42 is connected to a first terminal 50 that is outside the cap assembly 30 (refer to FIG. 2) and into which a connecting terminal 250 for moving a current is inserted, and the first terminal hole 4 may have a same shape as a cross-sectional shape of the connecting terminal 250, for example, a circular shape.

The second current collecting plate 44 contacts the second uncoated regions with a same polarity of the first electrode assembly 120a and the second electrode assembly 120b to electrically connect them. Therefore, the second current collecting plate 44 may be wider than the first current collecting plate 42.

In an embodiment, the second current collecting plate 44 may have first hole 8a and a second hole 8b, where the first hole 8a may be used to insert a jig during a process, and the second hole 8b is used to reduce vibrations in the case of ultrasonic welding.

In an embodiment, the second hole 8b includes a plurality of second holes 8b formed to be near a welding region (S) that is combined with the second uncoated region by ultrasonic welding, and the second holes 8b may be disposed in a matrix. In an embodiment, the second current collecting plate 44 is combined with the two electrode assemblies 120a and 120b, and two welding regions (S) may be formed and the second hole 8h may be formed between the welding regions (S).

In an embodiment the second holes 8b may be provided in the welding region respectively (not shown), and a space between the neighboring second holes 8b may be welded.

In an embodiment, the second holes 8b may be provided in a region through which the ultrasonic vibration is transmitted.

When the second holes 8b are formed according to an exemplary embodiment, the space between the second holes 8b forms a narrow bridge such that the vibrations generated by the ultrasonic welding are attenuated by the second holes 8b and the bridge. Therefore, it may be prevented or substantially prevented to crack the current collecting member by the ultrasonic vibrations. Particularly, a narrow region that is provided around a fuse hole 77 may be weak in the ultrasonic vibration, and according to embodiments of the present invention, the ultrasonic vibration is attenuated by formation of the second holes 8b such that it is intercepted for the ultrasonic vibrations to progress around the fuse and the fuse is prevented or substantially prevented from being damaged.

Referring to FIGS. 1 to 3, in an embodiment, the case 27 is substantially formed to be cuboidal, and an opening is formed in a first side thereof. The case 27 may be made of a metal, such as aluminum or stainless steel.

The cap assembly 30 includes a cap plate 31 for covering the opening of the case 27, the first terminal 50 outside the cap plate 31 and electrically connected to the first electrode 121, and a second terminal 52 outside the cap plate 31 and electrically connected to the second electrode 122.

The cap plate 31, in an embodiment, has a long plate shape extending 1n a direction and is combined to the opening of the case 27. The cap plate 31 may be formed with a same material as the case 27 and may be combined to the case 27 according to a laser welding method. Therefore, in an embodiment, the cap plate 31 may have a same polarity as the case 27.

In an embodiment, the cap plate 31 includes an electrolyte injection opening 32 for injecting an electrolyte solution, and a second terminal hole 5 into which the connecting terminal 250 is inserted. A vent plate 39 on which a notch 2 is formed may be installed in a vent hole 34 so as to be opened at a pressure (e.g., a predetermined pressure). A sealing stopper 38 is installed in the electrolyte injection opening 32, and the connecting terminal 250 is inserted into the second terminal hole 5.

The first terminal 50 and the second terminal 52 are respectively connected to the connecting terminals 250 and are provided on the cap plate 31.

The first terminal 50 is electrically connected to the first electrode 121 through the first current collecting member 140, and the second terminal 52 is electrically connected to the second electrode 122 through the second current collecting member 142. However, the present invention is not limited thereto, and the first terminal be electrically connected to the second electrode and the second terminal 52 may be electrically connected to the first electrode.

The first terminal 50, in an embodiment, is formed to have a rectangular plate shape. The connecting terminal 250 is inserted into a third terminal hole 9 of the first terminal 50 the first terminal hole 4 of the first current collecting plate 42, and the second terminal hole 5 of the cap plate 31 to electrically connect the first electrode 121 to the first terminal 50 with the connecting terminal 250 connected (e.g., bonded) to the first current collecting member 140 as a medium.

In an embodiment, the connecting terminal 250 is formed to have a column shape, and a top portion thereof is fixed to the first terminal 50 through welding while inserted into the third terminal hole 9. A bottom portion of the connecting terminal 250 is fixed to the first current collecting member 140 through welding while inserted into the first terminal hole 4. Therefore, the first electrode 121 is electrically connected to the first terminal 50 through the first current collecting member 140 and the connecting terminal 250.

A sealing gasket 59 is installed in the second terminal hole 5 to seal the space between the connecting terminal 250 and the cap plate 31.

In a like manner as the first terminal 50, the second terminal 52 is electrically connected to the second electrode 122 through the respective connecting terminal 250 inserted into the first to third terminal holes 4, 5, and 9 and the second current collecting member 142.

In an embodiment, a connecting member 58 is formed between the first terminal 50 and the cap plate 31, and a first insulating member 60 is formed between the second terminal 52 and the cap plate 31.

Therefore, in an embodiment, the case 27 and the cap plate 31 are electrically connected to the first terminal 50 through the connecting member 58 such as to be charged with a same polarity as the first electrode 121, and the second terminal 52 is insulated from the cap plate 31 by the first insulating member 60.

In an embodiment, a short circuit protrusion 3 protruding toward a short circuit hole 37 formed in the cap plate 31 is formed at a bottom portion of the second terminal 52. The second terminal 52 is formed to extend in a direction so as to cover the short circuit hole 37. Therefore, the first insulating member 60 may be installed along the second terminal 52 and may be formed to wrap a side of the second terminal 52.

In an embodiment, a short circuit member 56 connected with a side wall of the short circuit hole 3 to short circuit the first electrode 121 and the second electrode 122 is installed in the short circuit hole 37 of the cap plate 31.

The short circuit member 56 may include a curved portion formed to be bent in a convex arc toward the electrode assembly 120 and an edge portion formed on a winding side of the curved portion and fixed to a side wall of the short circuit hole 37.

When a gas occurs due to an abnormal reaction inside the rechargeable battery, an internal pressure of the rechargeable battery increases. When the internal pressure of the rechargeable battery becomes higher than a pressure (e.g., a predetermined pressure), the curved portion becomes convex irk a direction of the second terminal 52, and contacts the short circuit protrusion 3 of the second terminal 52 to cause a short circuit. As described, when the short circuit occurs, a battery reaction no longer occurs and an explosion caused by an increase of internal pressure may be prevented or substantially prevented from occurring.

A second insulating member 62 is formed among the cap plate 31, the first current collecting member 140 and the second current collecting member 142 and a third insulating member 64 is formed among the first current collecting member 140 the second current collecting member 142, and the electrode assembly 120.

The electrode assembly 120 may be surrounded by an insulating case 130, and the second insulating member 62 may be integrally formed with the insulating case 130.

The second insulating member 62 and the third insulating member 64 may perform an insulation function, and may also support the first current collecting member 140 and the second current collecting member 142.

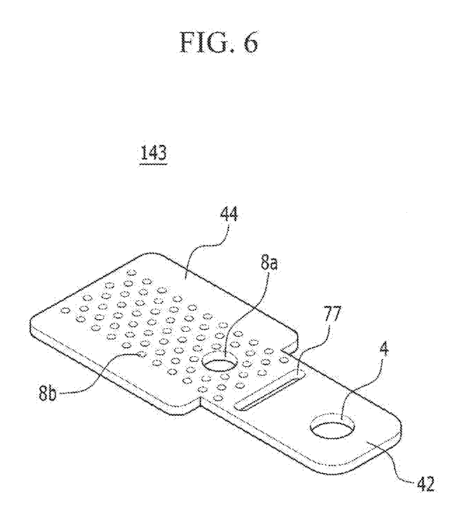

FIG. 6 to FIG. 11 show perspective views of a current collecting member according to further exemplary embodiments.

Current collecting members 143, 144, 145, 146, 147, and 148 shown in FIG. 6 to FIG. 11 correspond to the current collecting member 140 show in FIG. 5 in many ways, and portions which are different will be described in further detail. The current collecting members of FIG. 6 to FIG. 11 may be used as the first current collecting member or the second current collecting member.

The current collecting member 143 of FIG. 6 may be connected such that the second current collecting plate 44 and the first current collecting plate 42 may have a flat shape and may be integral. The first current collecting plate 42 connected to the second current collecting plate 44 may be narrower than the second current collecting plate 44.

The second current collecting plate 44 may include a first hole 8a and a plurality of second holes 8b, and the plurality of second holes 8b may be disposed as a matrix. In an embodiment, a fuse hole 77 is formed in an edge of the first current collecting plate 42 provided near the second current collecting plate 44. The fuse ho 77 may be a slit formed along a side of the first current collecting plate 42.

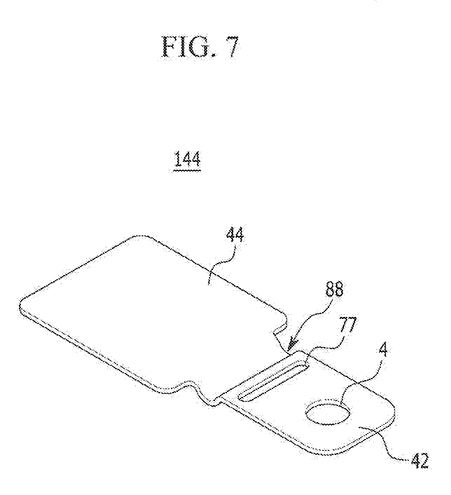

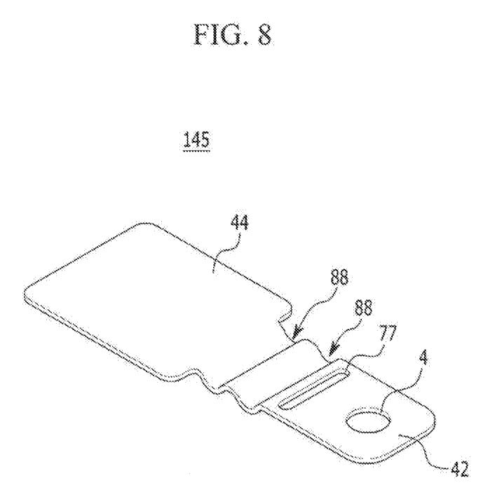

The current collecting members 144 and 145 shown in FIG. 7 and FIG. 8, respectively, include a first current collecting plate 42 and a second current collecting plate 44, and the first current collecting plate 42 is connected to the second current collecting plate 44. A wrinkle portion 88 is formed at a portion where the first current collecting plate 42 is connected to the second current collecting plate 44.

The wrinkle portion 88 may be a groove formed along a side of the first current collecting plate 42. As shown in FIG. 7, the groove may be formed to be one body. Further, as shown in FIG. 8, a plurality of grooves may be formed in parallel at intervals (e.g., at regular intervals). FIG. 8 shows two grooves, but the present invention is not limited to this, and further grooves may be formed.

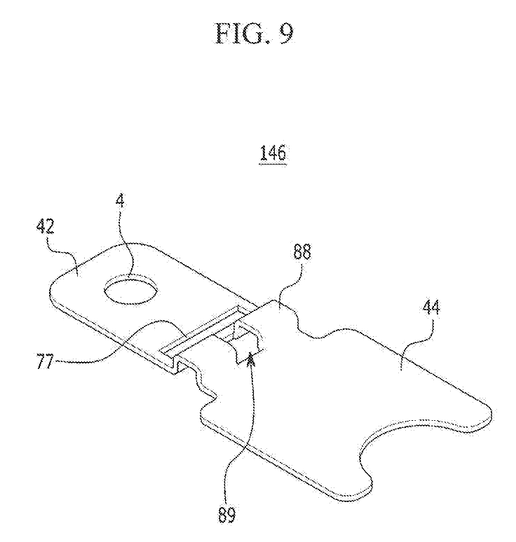

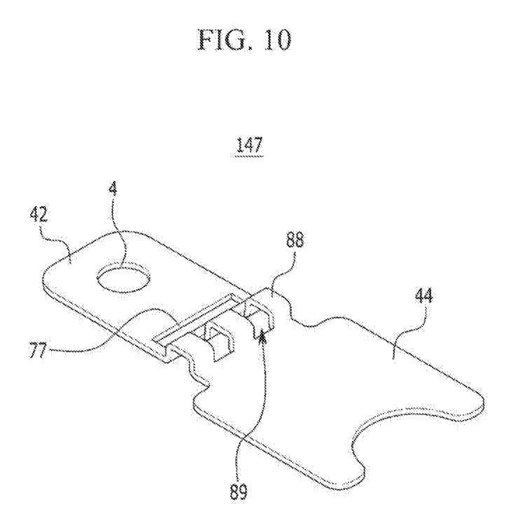

The current collecting members 146 and 147 shown in FIG. 9 and FIG. 10, respectively, include a first current collecting plate 42 and a second current collecting plate 44, and the first current collecting plate 42 is connected to the second current collecting plate 44. A wrinkle portion 88 is formed at a portion where the first current collecting plate 42 is connected to the second current collecting plate 44.

A through hole 89 is formed in the wrinkle portion 88 of the current collecting member shown in FIG. 9 and FIG. 10.

One through hole 89 may be formed as shown in FIG. 9, or a plurality of through holes 89 may be formed at intervals (e.g., at regular intervals) as shown in FIG. 10. FIG. 10 shows two through holes but the present invention is not limited to this, and further through holes may be formed.

In an embodiment, the through hole 89 may be substantially quadrangular with respect to a plane view, but the present invention is not limited to this, and, in another embodiment, the through hole 89 may be formed to be circular with respect o the plane view.

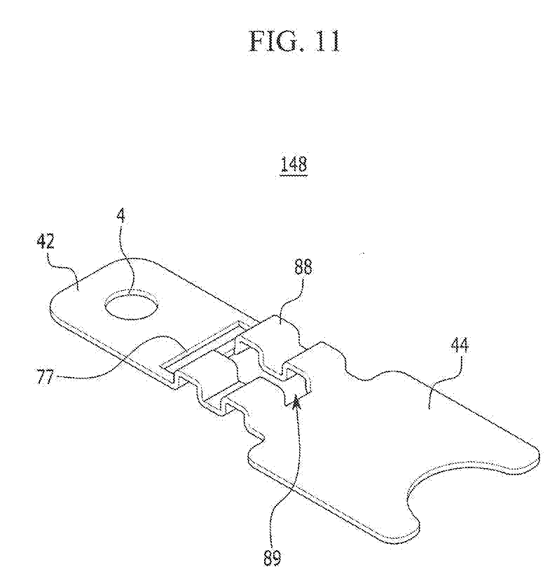

In another embodiment, a through hole 89 of the current collecting member 148 may be formed over plurality of wrinkle portions 88, as shown in FIG. 11.

While this disclosure has been described in connection with what are presently considered to be some practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
a first electrode assembly and a second electrode assembly, each comprising a first electrode and a second electrode configured with an electrode plate and an electrode uncoated region;
a case for receiving the first electrode assembly and the second electrode assembly and including an opening;
a cap assembly combined with the case to seal the opening; and
a current collecting member electrically connected between the electrode uncoated region of the first electrode assembly and the electrode uncoated region of the second electrode assembly,
wherein the current collecting member has a plurality of holes arranged between a first overlapping region of the current collecting member that overlaps a first side of the electrode uncoated region of the first electrode assembly and a second overlapping region of the current collecting member that overlaps a first side of the electrode uncoated region of the second electrode assembly.

2. The rechargeable battery of claim 1, wherein the holes are arranged as a matrix.

3. The rechargeable battery of claim 1,
wherein the current collecting member connects the first electrode of the first electrode assembly and the first electrode of the second electrode assembly, and
wherein the rechargeable battery further comprises another current collecting member connecting the second electrode of the first electrode assembly and the second electrode of the second electrode assembly.

4. The rechargeable battery of claim 1, wherein the current collecting member includes a first current collecting plate and a second current collecting plate connected with a first end of the first current collecting plate, and a wrinkle portion between the first current collecting plate and the second current collecting plate.

5. The rechargeable battery of claim 4, wherein the wrinkle portion has at least one through hole.

6. The rechargeable battery of claim 5, wherein the at least one through hole has a quadrangle shape with a long side extending in a direction traversing the wrinkle portion.

7. The rechargeable battery of claim 5, wherein the at least one through hole includes a plurality of through holes arranged at intervals in a length direction of the wrinkle portion.

8. The rechargeable battery of claim 4, wherein the first current collecting plate and the second current collecting plate are connected with each other in a stepwise manner.

9. The rechargeable battery of claim 6, wherein a first end of the first current collecting plate connected with the second current collecting plate is narrower than the second current collecting plate.

10. The rechargeable battery of claim 9, wherein the first current collecting plate includes a slit formed along the first end of the first current collecting plate connected with the second current collecting plate.

11. The rechargeable battery of claim 1, wherein the first electrode assembly and the second electrode assembly are respectively spirally wound with respect to a winding axis, and are inserted into the case in a direction parallel to the winding axis.

12. The rechargeable battery of claim 1, wherein the electrode uncoated region of the first electrode and the electrode uncoated region of the second electrode include a first uncoated region protruding toward the cap assembly from the electrode plate and a second uncoated region having a first side bent from the first uncoated region and contacting the current collecting member.

13. The rechargeable battery of claim 12, wherein the second uncoated region of the first electrode assembly and the second uncoated region of the second electrode assembly are bent in opposite directions to face each other.
